(19) United States
(12) Patent Application Publication
(10) Pub. No.: US 2009/0100469 A1
(43) Pub. Date: Apr. 16, 2009

(54) Recommendations from Social Networks

(75) Inventors: Jonathan L. Conradt, San Jose, CA (US); Vivienne C. Lee, San Jose, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/872,064

(22) Filed: Oct. 15, 2007

(51) Int. Cl. H04N 5/445

(52) U.S. Cl. 725/46

(57) ABSTRACT

Recommendations from social networks is described. In embodiment(s), communications data that is representative of communications between users of client devices can be collected. The communications data can then be evaluated to associate the users that communicate with each other, and a social network can be created that includes the associated users. Media content data that is representative of media content utilized by the associated users in the social network can be complied. A media content recommendation for a user can then be generated based on the compiled media content data for the associated users in the social network.

### BACKGROUND

Viewers have an ever-increasing selection of television programming and on-demand choices from which to choose from, and may want to locate programming and movie choices that are of interest to them. In addition to the scheduled television program broadcasts, viewing options also include the on-demand choices (e.g., movies) which enable a viewer to search for and request media content for viewing when convenient rather than at a scheduled broadcast time. Typically, a viewer can initiate a search for television programming choices and/or on-demand viewing choices in a program guide (also commonly referred to as an electronic program guide or “EPG”).

A typical program or movie description shown in a program guide or displayed when a particular program or movie is selected merely provides a short plot description, rating information, a list of some cast members, or other basic information about the selected media content. However, these simple program and movie descriptions rarely provide enough information for a viewer to decide whether a program or movie will be of interest to the viewer.

Collaborative filtering uses other people to help determine what someone similar may be interested in watching. The primary problem with collaborative filtering is being able to associate a group of people from which to base movie and other television program recommendations. Traditional techniques for collaborative filtering use characteristics of the people in a group, such as age, gender, race, and/or location to create the groups. However, these traditional techniques rely on a presumption that people having some similar characteristics also share similar interests in movies and television program viewing choices. Thus, these traditional techniques associate people that do not know each other into groups, and people may not have common interests or even any basis from which to determine a likelihood of interest in the same movies and program viewing choices.

### SUMMARY

This summary is provided to introduce simplified concepts of recommendations from social networks. The simplified concepts are further described below in the Detailed Description. This summary is not intended to identify essential features of the claimed subject matter, nor is it intended for use in determining the scope of the claimed subject matter.

Recommendations from social networks is described. In embodiment(s), communications data that is representative of communications between users of client devices can be collected. Communications between the users can include telephone communications, message communications, gaming sessions, and the like. The communications data can then be evaluated to associate the users that communicate with each other, and social network(s) can be created that include the associated users. Media content data that is representative of media content utilized by the associated users in the social network(s) can be compiled. A media content recommendation for a user can then be generated based on the compiled media content data for the associated users in the social network.

In other embodiment(s) of recommendations from social networks, television client devices associated with the users receive the communications data that is representative of the communications between the users. The communications data can include telephone communications data, such as session initiation protocol data that is utilized for caller-ID. The television client devices can forward the communications data to a content distributor that associates the users in the social network(s). As users in a social network utilize media content, such as movies, on-demand media content, and other television programs, the content distributor can compile the media content data that is representative of the media content. When the content distributor receives a request for a media content recommendation from a user via a television client device, the content distributor can determine the social network(s) associated with the user and generate a media content recommendation for the user.

### BRIEF DESCRIPTION OF THE DRAWINGS

Embodiments of recommendations from social networks are described with reference to the following drawings. The same numbers are used throughout the drawings to reference like features and components:

FIG. 1 illustrates an example system in which embodiments of recommendations from social networks can be implemented.

FIG. 2 illustrates another example system in which embodiments of recommendations from social networks can be implemented.

FIG. 3 illustrates example method(s) for recommendations from social networks in accordance with one or more embodiments.

FIG. 4 illustrates example method(s) for recommendations from social networks in accordance with one or more embodiments.

FIG. 5 illustrates various components of an example device which can implement embodiments of recommendations from social networks.

FIG. 6 illustrates various devices and components in an example entertainment and information system in which embodiments of recommendations from social networks can be implemented.

### DETAILED DESCRIPTION

Embodiments of recommendations from social networks provide that media content recommendations, such as for movies, can be generated utilizing social networks that include users who are more likely to have an association with each other, and therefore common interests and media content preferences. Communications data that is representative of communications between the users can be collected and evaluated to associate the users that communicate with each other. Communications between the users can include telephone communications, message communications, gaming sessions, and the like. Social networks can be formed that include the associated users and/or client devices that are associated by user account information. In an embodiment, the users can be associated based on a threshold for a minimum number of communications between the users that are included in a social network.

When the social networks have been established, media content data that is representative of media content utilized by the associated users in the social network(s) can be compiled. As users in the various social networks utilize services and/or media content, such as movies, on-demand media content, and other television programs, the media content data that is representative of the media content can be compiled. When a request for a media content recommendation from a user is received via a television client device, a content distributor of the media content can determine the social network(s) associated with the user. The content distributor can also generate a media content recommendation for the user based on the compiled media content data for the associated users in the social network(s). In addition, if a number of users associated in a social network are watching or recording a particular movie, the movie can be recommended to other members of the social network. A media content recommendation can also be communicated to members of the social network automatically or in response to a request for a recommendation.

In other embodiment(s), a user can have a user account that is associated with a variety of client devices, services, and so forth. The communications data that is representative of the various types of communications of the user (e.g., telephone communications, message communications, gaming sessions, and the like) can be collected and used to associate the user and/or the user account with a social network or networks. The social network(s) can be based on which of the other users and/or clients the user communicates with and optionally, how often. The user accounts can be managed by a content distributor that also provides media content to any number of the client devices, such as in a television environment. A user (via a respective client device) can access an associated user account to request and receive media content recommendations from the content distributor based on the social network(s) with which the user and/or user account is associated.

In other embodiment(s), a client device that is associated with a user, such as a television set-top box, can collect the communications data that is representative of the various types of communications of the user (e.g., telephone communications, message communications, gaming sessions, and the like). For example, a television client device can receive and/or route telephone communications data (e.g., session initiation protocol data for telephone, wireless phone, VOIP, etc.), message communications data (e.g., email messages, text messages, instant messages, pages, etc.), and/or gaming sessions data (e.g., user account information and the like). Any of the communications data may indicate which of the other users and/or client devices communicate with the user and how often.

The television client devices that collect communications data can then provide the collected communications data to a service that evaluates the communications data to associate the users who communicate with each other. The service or content distributor can then create the social network(s) or include the users and/or associated client device information in existing social network(s). The service can collect and store communications data from a variety of users and associated client devices. In various embodiments, the “service” can be implemented at a content distributor, at a client device, as a third party service, and/or as any combination thereof.

While features and concepts of the described systems and methods for recommendations from social networks can be implemented in any number of different environments, systems, and/or various configurations, embodiments of recommendations from social networks are described in the context of the following example systems and environments.

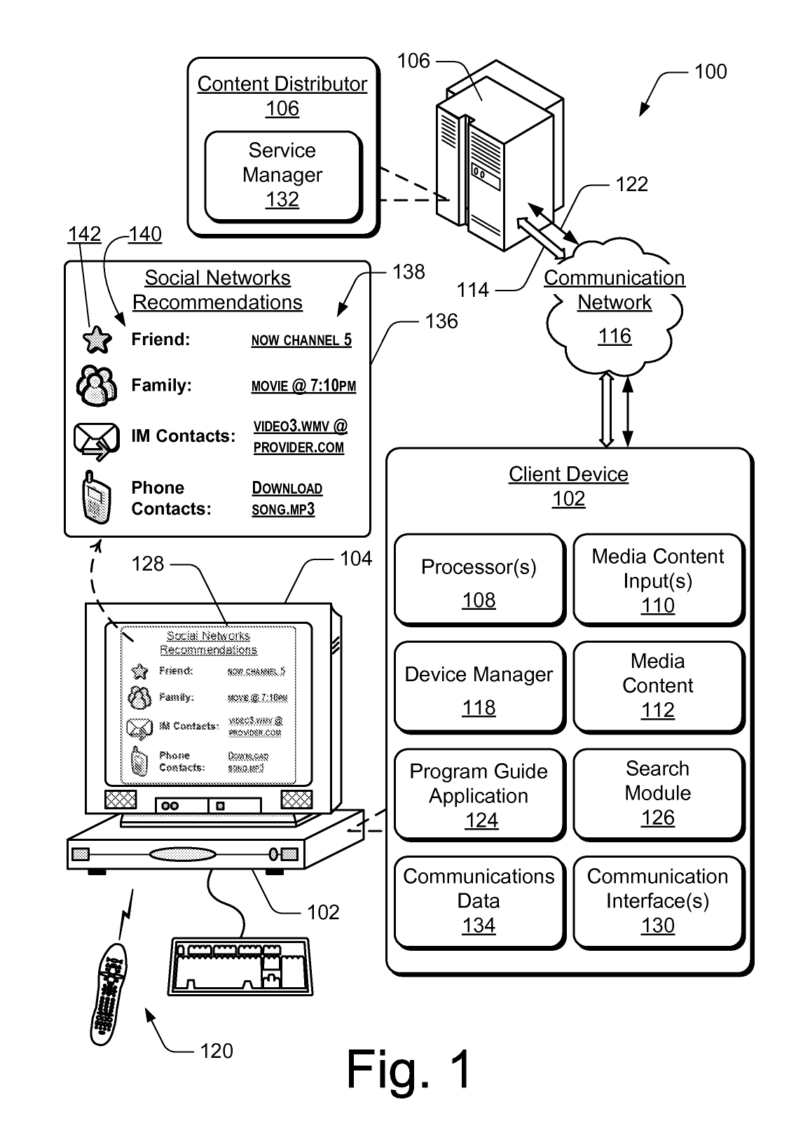

FIG. 1 illustrates an example system 100 in which various embodiments of recommendations from social networks can be implemented. In this example, system 100 includes a client device 102, a display device 104, and a content distributor 106. The client device 102 and display device 104 together are just one example of a television client system that can render audio, video, and/or image data. The display device 104 can be implemented as any type of a television, LCD, or similar display system.

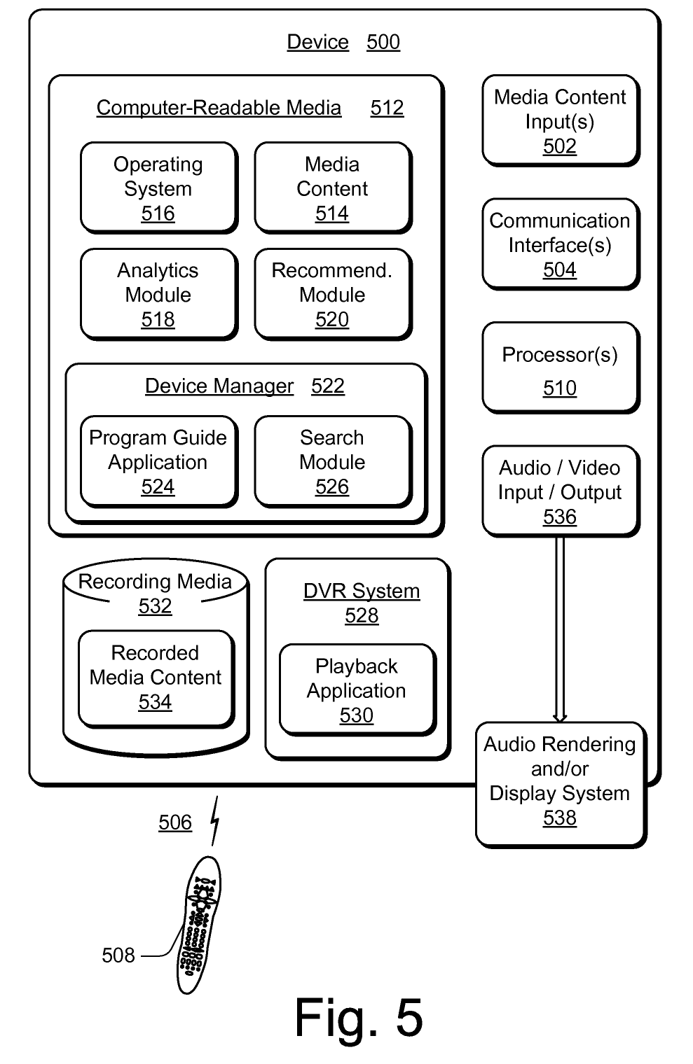

The example client device 102 can be implemented as any one or combination of a television set-top box, a digital video recorder (DVR) and playback system, an appliance device, a gaming console, a portable communication device, a portable computing device, and/or as any other type of television client device or computing-based device that may be implemented in a television entertainment and information system. Additionally, client device 102 can be implemented with any number and combination of differing components as further described with reference to the example device shown in FIG. 5.

Client device 102 may also be associated with a user or viewer (i.e., a person) and/or an entity that operates the device such that a client device describes logical clients that include users, software, and/or devices. For example, users may operate a respective client device 102 to access associated user accounts and to communicate with each other by way of telephone communications (e.g., telephone calls voice over internet protocol (VOIP) calls, mobile and/or cellular phone calls, pages, etc.), message communications (e.g., email messages, text messages, instant messages, etc.), and/or gaming sessions.

In the example system 100, client device 102 includes one or more processors 108 (e.g., any of microprocessors, controllers, and the like), media content inputs 110, and media content 112 (e.g., received media content or media content that is being received). The client device 102 can be configured for communication with various content distributor(s) 106 via an IP-based network 114 and/or communication network 116. The media content inputs 110 can include any type of communication interfaces and/or data inputs, such as Internet Protocol (IP) inputs over which streams of television media content (e.g., IPTV media content) are received via the IP-based network 114 and/or communication network 116. The media content inputs 110 can include any type of wireless, broadcast, and/or over-the-air inputs via which media content is received. The television client device 102 is configured for communication with the content distributor 106 via the IP-based and communication networks. A media content input 110 can receive television media content 112 as an IPTV multicast from the content distributor 106.

The IP-based network 114 can be implemented as part of the communication network 116 that facilitates media content distribution and data communication between the content distributor(s) 106 and any number of client devices, such as client device 102. The communication network 116 can be implemented as part of a media content distribution system using any type of network topology and/or communication protocol, and can be represented or otherwise implemented as a combination of two or more networks.

The media content 112 and/or recorded media content can include any type of audio, video, and/or image media content received from any type of media content source. As described throughout, “media content” can include television programs (or programming) which may be any form of programs, commercials, music, movies, and video-on-demand media content. Other media content can include interactive games, network-based applications, and any other audio, video, and/or image content (e.g., to include program guide application data, user interface data, search results and/or recommendations, and the like).

Client device 102 also includes a device manager 118 (e.g., a control application, software application, media content manager, etc.) that can be implemented as computer-executable instructions and executed by the processor(s) 108 to implement various embodiments of recommendations from social networks. The device manager 118 can incorporate a playback application to manage the presentation of media content 112 and/or recorded media content. The device manager 118 can also be implemented to monitor and/or receive selectable inputs (e.g., user selections) via an input device 120, and initiate communication of the viewer selections back to a content distributor 106. For example, a user can navigate an EPG, input search terms to initiate a search for media content, initiate interactions with the media content 112 (e.g., playback, record, delete, select), and so forth. A variety of input devices are contemplated such as a remote control device 120 and/or a computer keyboard.

The client device 102 can communicate the user-initiated selections to the content distributor 106 via a two-way data communication link 122 of the communication network 116. It is contemplated that any one or more of the arrowed communication links 122 and network 114, along with communication network 116, facilitate two-way data communication, such as from client device 102 to a content distributor 106 and vice-versa.

Client device 102 can also include a program guide application 124 and/or a search module 126, both of which can be implemented as computer-executable instructions and executed by the processor(s) 108 to implement embodiments of recommendations from social networks. The program guide application 124 can be implemented to process program guide data from which a program guide can be rendered and/or displayed for viewing on display device 104. A program guide may also be commonly referred to as an electronic program guide or an “EPG”. In this example, a user interface 128 of social network recommendations may be rendered on the display device 104 as a panel of a program guide interface and/or program search interface.

Although the program guide application 124 and the search module 126 are each illustrated and described as single applications (e.g., independent components of client device 102), each can be implemented as several component applications or modules distributed to implement various embodiments of recommendations from social networks. Alternatively, the program guide application 124 and the search module 126 can be implemented together as a multi-functional component of client device 102 to implement embodiments of recommendations from social networks.

In an embodiment, the search module 126 can receive a search request for media content when initiated by a viewer at client device 102, and initiate that media content relevant to the search request be rendered for display. In addition, the search module 126 can communicate with a search service that is provided at the content distributor 106 via the two-way data communication link 122 and/or the communication network 116.

In this example system 100, the client device 102 can include various communication interface(s) 130 by which the device manager 11 8 can interact to form, send, receive, and/or process various communications between the client device 102 and the content provider 106 and/or other electronic and computing devices. The communication interface(s) 130 can be implemented as any one or more of a serial and/or parallel interface, a wireless interface, any type of network interface, a modem, and as any other type of communication interface. The client device 102 can be implemented with the various communication interface(s) 130 to receive, process, and/or further communicate a variety of communication types according to different communication modes and protocols. The various communications that may be received through client device 102 can include media content requests, content distributions, control inputs, email messages, instant messages, text messages, voice over internet protocol (VOIP) calls, cellular and traditional phone calls, network gaming sessions and chats, and so forth.

The content distributor 106 includes a service manager 132 that can be implemented to manage services and distribution of media content to any number of client devices, such as client device 102. The service manager 132 can manage client device access (e.g., user and/or client authentication) to various services and media content, can include functionality to create social networks of users and/or associated client devices, and can generate and provide media content recommendations based on the social networks.

The service manager 132 can include a service that is implemented to collect, process, manage, and/or receive communications data, and evaluate the communications data to associate users that communicate with each other. The service manager 132 can receive the communications data from client devices, such as client device 102. In an embodiment, client device 102 collects communications data 134 that is representative of the various types of communications of a user associated with the client device (e.g., telephone communications, message communications, gaming sessions, and the like). For example, client device 102 can receive and/or route telephone communications data (e.g., session initiation protocol data for telephone, wireless phone, VOIP, etc.), message communications data (e.g., email messages, text messages, instant messages, pages, etc.), and/or gaming sessions data (e.g., user account information and the like). Any of the communications data collected by the service manager 132 may indicate which of the various users and/or client devices communicate with each other and how often.

The service manager 132 can also include a service that is implemented to form social networks based on the communications data collected from various client devices. The social networks can include users and/or client devices that are associated by user account information. In an embodiment, the users can be associated based on a threshold for a minimum number of communications between the users that are included in a social network. The service manager 132 can also include a service that is implemented to compile media content data that is representative of media content utilized by the associated users in the social network(s). As users in the various social networks utilize services and/or media content, such as movies, on-demand media content, and other television programs, the media content data that is representative of the media content can be compiled.

The service manager 132 can also include a service to then generate a media content recommendation 136 for a user based on the compiled media content data for the associated users in the social network(s). For example, the service manager 132 can provide a media content recommendation to client device 102 that can be displayed as the user interface 128. In this example, the media content recommendation 136 includes social networks recommendations 138 for various media content as determined from respective social networks 140. The social networks 140 included in the media content recommendation 136 include a “Friend”, “Family”, “IM Contacts”, and “Phone Contacts” along with corresponding social networks recommendations 138 for media content.

The social networks recommendations 138 can be displayed on the user interface 128 as user-selectable links or controls which may be selected by a viewer to initiate a display of the corresponding media content. Alternatively, a viewer selection of a user-selectable link may initiate a display of another media content recommendation, initiate tuning to a corresponding channel to receive the selected media content, and the like. The user interface 128 for a media content recommendation 136 can also include visual representations 142 (e.g., icons, avatars, user tiles, etc.) of the different social networks 140. In another example, the social networks recommendations 138 can be organized into particular content categories such as movies, sports, music, Internet, drama, news, or other suitable categories.

A variety of different user interfaces for media content recommendations are contemplated, such as a display of recommendations generated from a single social network. A media content recommendation may also include one or multiple content categories, different pages or tabs for different social networks and/or categories, multiple recommendations for several social networks, recommendations arranged according to a frequency of communications between the users associated in a social network, and so forth. The social networks recommendations 138 can also be arranged by different priorities of recommendations from different groups or social networks. A priority can be based on how often communication occurs between particular users, or optionally, can be user-configurable.

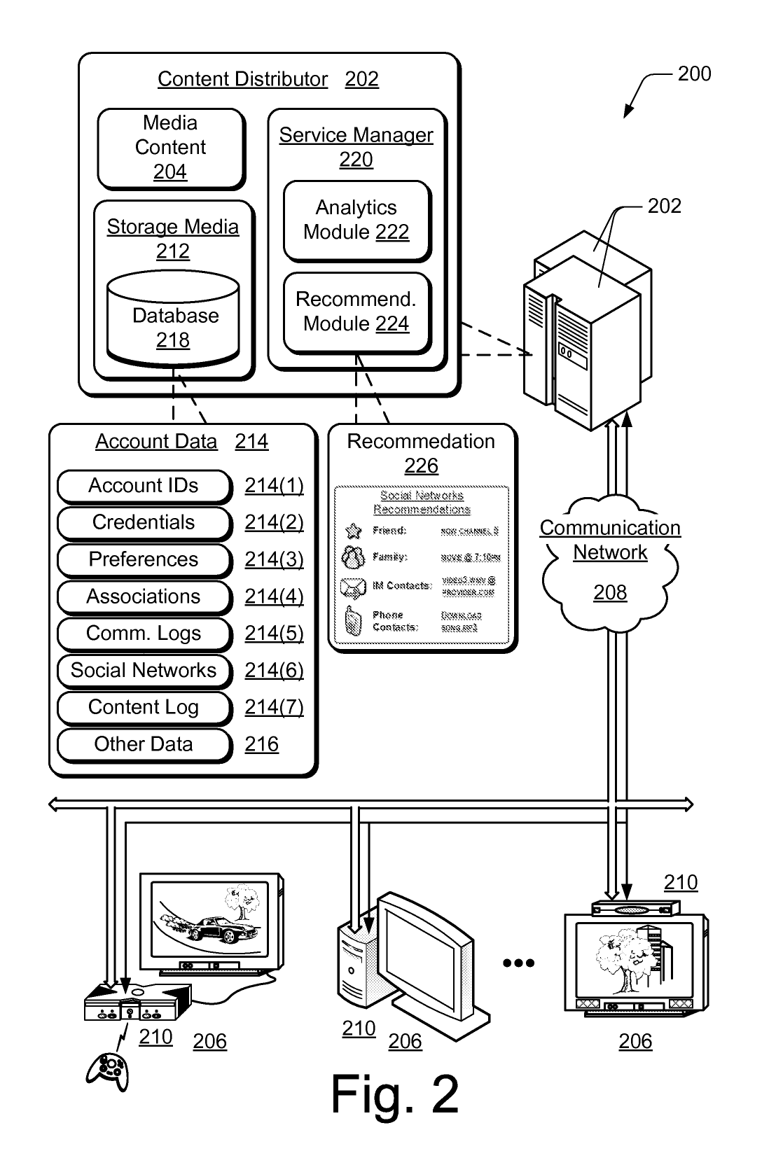

FIG. 2 illustrates another example system 200 in which various embodiments of recommendations from social networks can be implemented. The example system 200 includes content distributor(s) 202 that communicate media content 204 to any number of various television client systems 206 via a communication network 208. An example of a communication network is described with reference to communication network 116 shown in FIG. 1. An example of a client device in a television client system 206 is described with reference to client device 102 as also shown in FIG. 1. The communication network 208 can be implemented to include an IP-based network and/or a broadcast network that both facilitate media content distribution and data communication between the content distributor(s) 202 and any number of television client devices.

Each of the television client systems 206 include a respective client device 210 and a display device, such as any type of television, monitor, LCD, or similar television-based display system that renders audio, video, and/or image data. Any of the client devices 210 can be implemented as any one or combination of a television client device, a digital video recorder (DVR), an appliance device, a gaming console, a computer device, a mobile phone, a portable device, and/or as any other type of client device.

Any of the client devices 210 of the respective client systems 206 can be implemented with one or more processors, communication components, memory components, and a media content rendering system. Any of the client devices 210 can also include a device manager, such as device manager 118 described with reference to FIG. 1. Additionally, each of the client devices 210 can be configured for communication with any number of different content distributors 202 to receive any type of media content 204 via the communication network 208. Further, any of the client devices 210 can be implemented with any number and combination of differing components as further described with reference to the example device shown in FIG. 5.

In this example, a content distributor 202 includes storage media 212 to store various data, such as user associated account data 214 and/or other account data 216 in a database 218. The content distributor 202 also includes a service manager 220 that can implement embodiments of recommendations from social networks, as well as operating to provide media content 204 and other services to client systems 206 via the communication network 208. The service manager 214 includes an analytics module 222 and a recommendation module 224 that can each implement aspects of recommendations from social networks.

The analytics module 222 can be implemented to collect and/or receive communications data from any number of the client devices 210 where the communications data is representative of communications between users of client devices. The analytics module 222 can evaluate the communications data and/or the account data 214 to associate the users that communicate with each other and/or to associate user accounts corresponding to the users. In an embodiment, the users and/or user accounts can be associated based on a threshold for a minimum number of the communications between the users that are included in the social network. The analytics module 222 can then create a social network of the associated users that communicate with each other.

The recommendation module 224 can be implemented to compile media content data that is representative of media content utilized by the associated users in the social networks, and in response to a request for a media content recommendation, generate the media content recommendation 226 based on the compiled media content data for the associated users. When a request for a media content recommendation is received from client device 210, the recommendation module 224 can determine the social network(s) associated with the requesting user, and generate the recommendation 226 to include a plurality of recommendations for media content based on the determined social network(s) associated with the user.

Although illustrated as described as components of the service manager 220 at content distributor 202, the analytics module 222 and the recommendation module 224 can be implemented as stand-alone components to implement embodiments of recommendations from social networks. The analytics module 222 and/or the recommendation module 224, as well as other functionality described to implement recommendations from social networks, can also be provided by a service apart from the content distributor 202 (e.g., on a separate server or by a third party service).

The account data 214 and/or other account data 216 can be data that is related to various user accounts, associated users, and/or client devices 210. The account data 214 can include a variety of account data 214(1-7), examples of which are described below. The other account data 216 can include a variety of data, such as demographic data, billing data, service data describing selected services and authorizations, data describing a preferred client device to receive media content 204, programming guide data to form an EPG, and so forth. The service manager 220, through operation of the analytics module 222 and/or the recommendation module 224, can collect, compile, maintain, access, process, and otherwise manage the database 218 and associated account data 214.

The account data 214 can include a variety of authentication data for a user or client device, such as account identifiers 214(1) and credentials 214(2) (e.g., user name and password). The account data 214 can also include user preferences 214(3) and associations 214(4) of a user (e.g., associations of the account of the user) to different services, content providers, client systems 206 and/or other accounts. In this manner, a variety of different services and/or accounts with different providers may be associated to one another and managed together to provide recommendations from social networks.

In various embodiments, account data 214 can include data describing the communications of various users and/or client devices which is maintained as communication logs 214(5). The analytics module 222 can collect the various account data 214 representative of communications between different users. For example, phone numbers and related data can be gathered from a caller identification system of a client device 210. Email contacts, contact groups, and related data can be gathered from an email account associated with a user or client device 210. Text messages or instant messages and related data can be gathered from a messaging application and/or system of a client device 210. Gaming sessions, gamer identities, or chats and related data can be gathered from a client device 210 when implemented for network gaming functionality.

The analytics module 222 can analyze the communication logs 214(5) data to form social networks 214(6). Thus, a user can be associated with different social networks 214(6) by the account data 214. The social networks 214(6) can be based upon which users communicate with each other, how often they communicate, the type of communications, and so forth. Communications data can also include user specified categories, such as different categories of contacts. For instance, a user's email, phone, or other contacts can be arranged into groups such as a top five list of friends, work contacts, family, etc. These group arrangements can be included with data collected by the analytics module 222. Other categories for social networks 214(6) may include a primary individual contact, a hobby group, a social organization, and so forth.

Based on an analysis of the communication logs 214(5), the analytics module 222 can determine a group of users who contact each other regularly. In one embodiment, the analytics module 222 can communicate an invitation to form or join a social network 214(6) to a group of associated users. In another embodiment, a social network of associated users and/or client devices can be automatically formed based upon a threshold minimum of communications between the associated users. The threshold minimum can be configurable to specify a number of communications over a particular duration, such as a number of communications per day, a number of communications per month, and so on.

The account data 214 can also include a content log 214(7) to compile media content data that is representative of media content utilized by the users in the social network(s). The recommendation module 224 can collect a variety of media content data, such as content selections, content identifiers, recommendations of users in a social network, on-demand selections, a list of scheduled recordings, website addresses, etc. The recommendation module 224 can then analyze the content log 214(7) and/or similar data to determine media content recommendation(s) 226 from social networks 214(6) that can be formed by the analytics module 222.

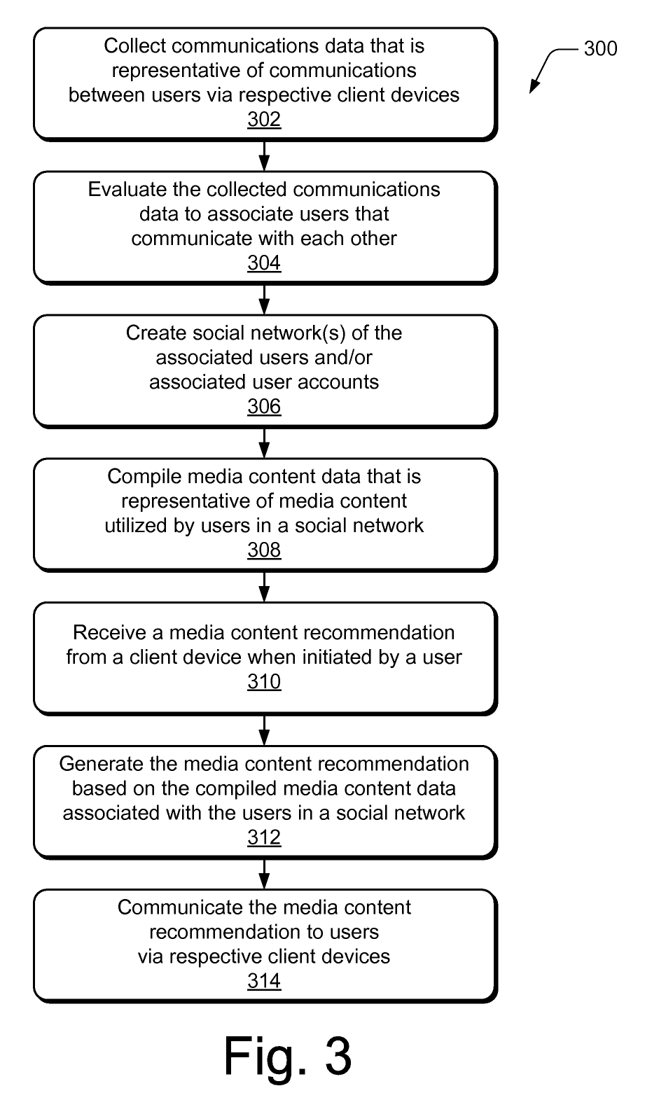

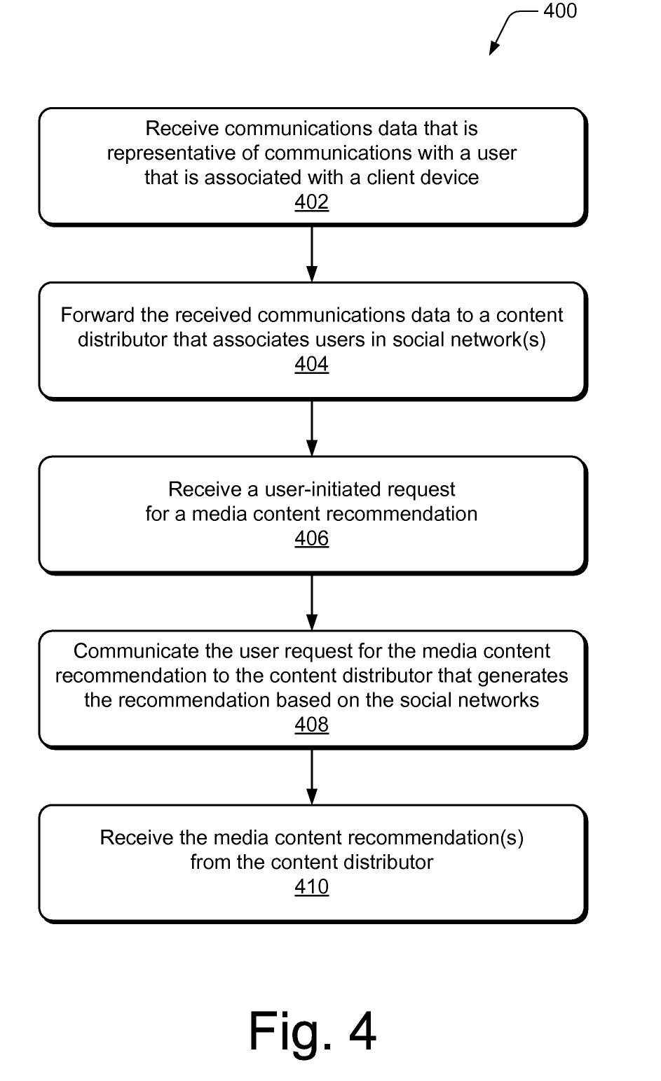

Generally, any of the functions, methods, procedures, and modules described herein can be implemented using hardware, software, firmware (e.g., fixed logic circuitry), manual processing, or any combination thereof. A software implementation of a function, method, procedure, or module represents program code that performs specified tasks when executed on a computing-based processor. Example methods 300 and 400 described with reference to respective FIGS. 3 and 4 may be described in the general context of computer-executable instructions. Generally, computer-executable instructions can include applications, routines, programs, objects, components, data structures, procedures, modules, functions, and the like that perform particular functions or implement abstract data types.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of recommendations from social networks, and is described with reference to a content distributor and/or service provider. The order in which the method is described is not intended to be construed as a limitation, and any number of the described method blocks can be combined in any order to implement the method, or an alternate method.

At block 302, communications data is collected that is representative of communications between users via respective client devices. For example, the analytics module 222 at content distributor 202 (FIG. 2) receives communications data from various users and/or collects a variety of communications data from any number of client devices 210. The communications data can be representative of any type of communications of the users, such as any type of telephone communications, message communications, gaming sessions, and the like.

At block 304, the communications data is evaluated to associate users that communicate with each other, and at block 306, social network(s) of the users and/or associated user accounts are created based on the collected communications data. For example, the analytics module 222 at content distributor 202 analyzes or otherwise evaluates the collected communications data to associate the users who communicate with each other. In addition, the analytics module 222 associates user accounts that correspond to the users. In an embodiment, the analytics module 222 associates the users and/or the user accounts based on a threshold for a minimum number of the communications between users that are included in a social network. The analytics module 222 then creates the social network(s) of the associated users based on the communications data.

At block 308, media content data that is representative of media content utilized by the users in a social network is compiled. For example, the recommendation module 224 at content distributor 202 compiles media content data, such as movies, on-demand media content, and other television programs, as users in the various social networks utilize services and/or the media content.

At block 310, a request for a media content recommendation is received from a client device (e.g., when initiated by a user in a social network), and at block 312, the media content recommendation is generated based on the compiled media content data associated with the users in a social network. For example, the recommendation module 224 at content distributor 202 receives a request for a media content recommendation from a client device 210. The recommendation module 224 then generates the media content recommendation 226 based on the compiled media content data that is associated with users and/or user accounts in a social network.

At block 314, the media content recommendation is communicated to the requesting user (or users) via respective client devices. For example, the recommendation module 224 initiates communicating the media content recommendation 226 to the client devices 210 via communication network 208.

FIG. 4 illustrates example method(s) 400 of recommendations from social networks, and is described with reference to a client device. The order in which the method is described is not intended to be construed as a limitation, and any number of the described method blocks can be combined in any order to implement the method, or an alternate method.

At block 402, communications data that is representative of communications with a user is received at a client device associated with the user. For example, a client device 102 (FIG. 1) that is associated with a user (or users) receives communications data 134 that is representative of various communications between the user associated with the client device 102 and other users. The communications data 134 received at client device 102 can include telephone communications data, message communications data, gaming sessions data, and the like.

At block 404, the communications data is forwarded to a content distributor that associates users in social network(s). For example, client device 102 forwards or otherwise communicates the communications data 134 to content distributor 106 that evaluates the communications data to associate users that communicate with each other into the social network(s).

At block 406, a user-initiated request for a media content recommendation is received, and at block 408, the request for the media content recommendation is communicated to the content distributor that generates the recommendation based on the social networks. For example, client device 102 receives selectable inputs (e.g., user selections) via input device 120 and initiates communication of the viewer selections to content distributor 106.

At block 410, the media content recommendation is received from the content distributor. For example, client device 102 receives the media content recommendation 136 from content distributor 106 which is displayed as the user interface 128, and includes social networks recommendations 138 for various media content as determined from respective social networks 140 at the content distributor.

FIG. 5 illustrates various components of an example device 500 that can be implemented as any form of a computing, electronic, appliance, television client device, or television system device to implement various embodiments of recommendations from social networks. For example, device 500 can be implemented as a television client device or as a content distributor as shown in any of FIGS. 1-2. In various embodiments, device 500 can be implemented as any one or combination of a television client device, a digital video recorder (DVR), a gaming system or console, a computing-based device, an appliance device, and/or as any other type of similar device.

Device 500 includes one or more media content inputs 502 that may include Internet Protocol (IP) inputs over which streams of media content are received via an IP-based network. Device 500 further includes communication interface(s) 504 that can be implemented as any one or more of a serial and/or parallel interface, a wireless interface, any type of network interface, a modem, and as any other type of communication interface. A network interface provides a connection between device 500 and a communication network by which other electronic and computing devices can communicate data with device 500.

Similarly, a serial and/or parallel interface provides for data communication directly between device 500 and the other electronic or computing devices. A modem also facilitates communication with other electronic and computing devices via a conventional telephone line, a DSL connection, cable, and/or other type of connection. A wireless interface enables device 500 to receive control input commands 506 and other data from an input device, such as from remote control device 508, a portable computing-based device (such as a cellular phone), or from another infrared (IR), 802.11, Bluetooth, or similar RF input device.

Device 500 also includes one or more processors 510 (e.g., any of microprocessors, controllers, and the like) which process various computer-executable instructions to control the operation of device 500, to communicate with other electronic and computing devices, and to implement embodiments of recommendations from social networks. Device 500 can be implemented with computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 512 provides data storage mechanisms to store media content 514, as well as computer applications and any other types of information and/or data related to operational aspects of device 500. For example, an operating system 516 can be maintained as a computer application with the computer-readable media 512 and executed on processor(s) 510 to implement embodiments of recommendations from social networks.

The computer applications can include an analytics module 518 and a recommendation module 520 when device 500 is implemented as a content distributor, and/or can include a device manager 522 when implemented as a television client device. The analytics module 518, recommendation module 520, and device manager 522 are shown as software modules in this example to implement various embodiments of recommendations from social networks as described herein. An example of the analytics module 518 and recommendation module 520 are described with reference to analytics module 222 and recommendation module 224 for content distributor 202 as shown in FIG. 2, and an example of the device manager 522 is described with reference to device manager 118 for client device 102 as shown in FIG. 1. The functionality of program guide application 124 and search module 126 shown in FIG. 1 can be incorporated with the device manger 522 of device 500, such as the example program guide application 524 and search module 526.

When implemented as a television client device, the device 500 can also include a DVR system 528 with playback application 530, and recording media 532 to maintain recorded media content 534 that device 500 receives and/or records. The recorded media content 534 can include the media content 514 that is received from a content distributor and recorded. For example, the media content 534 can be recorded when received as a viewer-scheduled recording, or when the recording media 532 is implemented as a pause buffer that records the media content 534 as it is being received and rendered for viewing. In various embodiments of recommendations from social networks, the recorded media content 534 can include media content 514 that is recorded based upon a content recommendation that is output to one or more users in a social network.

Further, device 500 may access or receive additional recorded media content that is maintained with a remote data store (not shown). Device 500 may also receive media content from a video-on-demand server, or media content that is maintained at a broadcast center or content distributor that distributes the media content to subscriber sites and client devices. The playback application 530 can be implemented as a media control application to control the playback of media content 514, the recorded media content 534, and/or any other audio, video, and/or image media content which can be rendered and/or displayed for viewing.

Device 500 also includes an audio and/or video output 536 that provides audio and/or video data to an audio rendering and/or display system 538. The audio rendering and/or display system 538 can include any devices that process, display, and/or otherwise render audio, video, and image data. Video signals and audio signals can be communicated from device 500 to a display device via an RF (radio frequency) link, S-video link, composite video link, component video link, DVI (digital video interface), analog audio connection, or other similar communication link. Alternatively, the audio rendering and/or display system 538 can be implemented as integrated components of the example device 500.

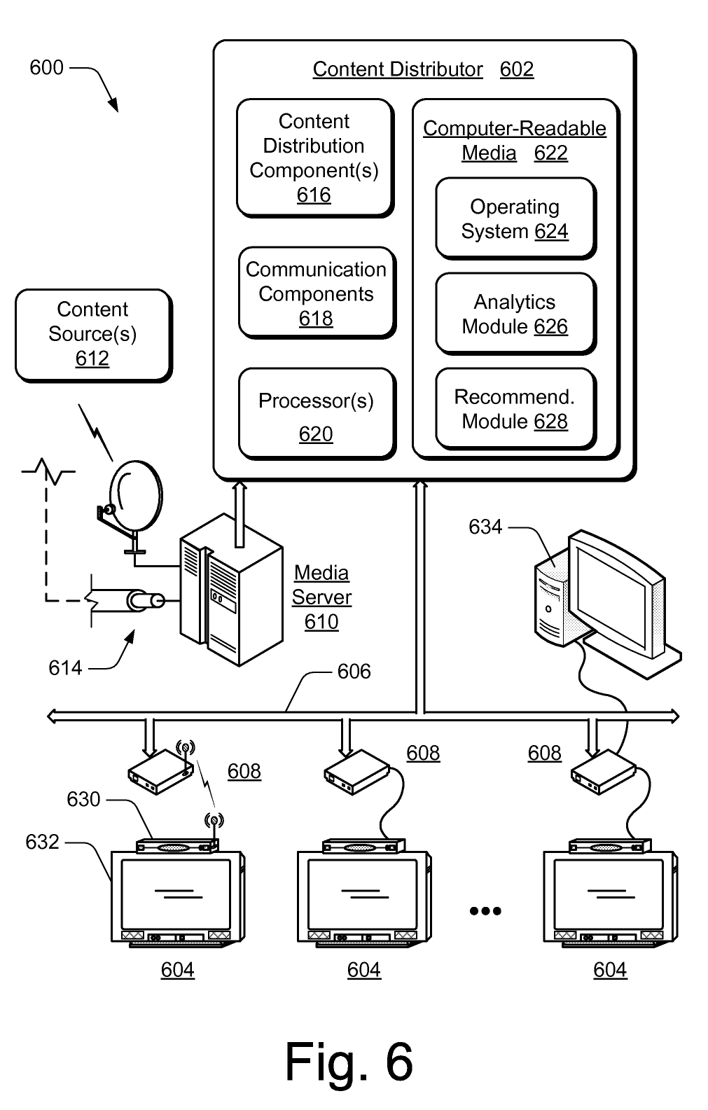

FIG. 6 illustrates an example entertainment and information system 600 in which embodiments of recommendations from social networks can be implemented. System 600 facilitates the distribution of media content, program guide data, and/or advertising content to multiple viewers and viewing systems. System 600 includes a content distributor 602 and any number of client systems 604 each configured for communication via a communication network 606. Each of the client systems 604 can receive data streams of media content, program content, program guide data, advertising content, closed captions data, and the like from content server(s) of the content distributor 602 via the communication network 606.

The communication network 606 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 606 can be implemented using any type of network topology and any network communication protocol, and can be represented or otherwise implemented as a combination of two or more networks. A digital network can include various hardwired and/or wireless links 608, such as routers, gateways, and so on to facilitate communication between content distributor 602 and the client systems 604.

System 600 includes a media server 610 that receives content from various content sources 612, such as media content from a content provider, program guide data from a program guide source, and advertising content from an advertisement provider. In an embodiment, the media server 610 represents an acquisition server that receives audio and video content from a provider, an EPG server that receives the program guide data from a program guide source, and/or an advertising management server that receives the advertising content from an advertisement provider.

The content sources, such as the content provider, program guide source, and the advertisement provider control distribution of the media content, the program guide data, and the advertising content to the media server 610 and/or to other servers of system 600. The media content, program guide data, and advertising content can be distributed via various transmission media 614, such as satellite transmission, radio frequency transmission, cable transmission, and/or via any number of other wired or wireless transmission media. In this example, media server 610 is shown as an independent component of system 600 that communicates the program content, program guide data, and advertising content to content distributor 602. In an alternate implementation, media server 610 can be implemented as a component of content distributor 602.

Content distributor 602 is representative of a headend service in a content distribution system, for example, that provides the media content, program guide data, and advertising content to multiple subscribers (e.g., the client systems 604). The content distributor 602 can be implemented as a satellite operator, a network television operator, a cable operator, and the like to control distribution of media content, program and advertising content, such as movies, television programs, commercials, music, and any other audio, video, and/or image content to the client systems 604.

Content distributor 602 includes various content distribution components 616 to facilitate media content processing and distribution, such as a subscriber manager, a device monitor, and one or more content servers. The subscriber manager manages subscriber data, and the device monitor monitors the client systems 604 (e.g., and the subscribers), and maintains monitored client state information.

Although the various managers, servers, and monitors of content distributor 602 (to include the media server 610 in one embodiment) are described as distributed, independent components of content distributor 602, any one or more of the managers, servers, and monitors can be implemented together as a multi-functional component of content distributor 602. Additionally, any one or more of the managers, servers, and monitors described with reference to system 600 can implement features and embodiments of recommendations from social networks.

The content distributor 602 includes communication components 618 that can be implemented to facilitate media content distribution to the client systems 604 via the communication network 606. The content distributor 602 also includes one or more processors 620 (e.g., any of microprocessors, controllers, and the like) which process various computer-executable instructions to control the operation of content distributor 602. The content distributor 602 can be implemented with computer-readable media 622 which provides data storage to maintain software applications such as an operating system 624, analytics module 626, and a recommendation module 628. The analytics module 626 and recommendation module 628 can implement one or more embodiments of recommendations from social networks as described with reference to analytics module 222 and recommendation module 224 for content distributor 202 shown in FIG. 2.

The client systems 604 can each be implemented to include a client device 630 and a display device 632 (e.g., a television, LCD, and the like). A client device 630 of a respective client system 604 can be implemented in any number of embodiments, such as a set-top box, a digital video recorder (DVR) and playback system, an appliance device, a gaming system, and as any other type of client device that may be implemented in an entertainment and information system. In an alternate embodiment, a client system 604 may be implemented with a computing device 634 as well as a client device. Additionally, any of the client devices 630 of a client system 604 can implement features and embodiments of recommendations from social networks as described herein.

Although embodiments of recommendations from social networks have been described in language specific to features and/or methods, it is to be understood that the subject of the appended claims is not necessarily limited to the specific features or methods described. Rather, the specific features and methods are disclosed as example implementations of recommendations from social networks.

1. A method, comprising:
collecting communications data that is representative of communications between users via respective client devices;
creating a social network of the users based on the collected communications data;
compiling media content data that is representative of media content utilized by the users in the social network; and
generating a media content recommendation for a user in the social network based on the compiled media content data associated with the users in the social network.

2. A method as recited in claim 1, further comprising:
receiving a request for the media content recommendation from a television client device when initiated by the user; and
communicating the media content recommendation to the television client device.

3. A method as recited in claim 1, further comprising:
receiving the communications data from the respective client devices;
evaluating the communications data to create the social network; and
including the user in the social network based on the communications data received from the respective client devices.

4. A method as recited in claim 1, wherein the respective client devices are television set-top boxes, and wherein the users are associated in the social network based on telephone communications data that is received by the television set-top boxes.

5. A method as recited in claim 4, wherein the telephone communications data includes session initiation protocol data that is received by the television set-top boxes.

6. A method as recited in claim 1, wherein the respective client devices include mobile phones that are utilized by the users for the communications.

7. A method as recited in claim 1, wherein creating the social network includes a threshold for a minimum number of the communications between the users that are included in the social network.

8. A method as recited in claim 1, further comprising associating user accounts corresponding to the users, and wherein the social network is further created based on associated user accounts corresponding to the users that are included in the social network.

9. A method as recited in claim 1, wherein the communications between the users are selected from a group comprising: telephone communications; message communications; or gaming sessions.

10. A method as recited in claim 1, wherein the respective client devices that facilitate the communications between the users are selected from a group comprising: a television set-top box; a mobile phone; a computing device; or a gaming console.

11. A content distributor, comprising:
an analytics module configured to:
collect communications data that is representative of communications between users of client devices;
evaluate the communications data to associate the users that communicate with each other;
create a social network of the associated users that communicate with each other; and
a recommendation module configured to:
compile media content data that is representative of media content utilized by the associated users in the social network; and
generate a media content recommendation based on the compiled media content data for the associated users.

12. A content distributor as recited in claim 11, wherein the analytics module is further configured to associate the users based on a threshold for a minimum number of the communications between the users that are included in the social network.

13. A content distributor as recited in claim 11, wherein the analytics module is further configured to receive the communications data from the client devices.

14. A content distributor as recited in claim 11, wherein the client devices are television set-top boxes, and wherein the analytics module is further configured to associate the users in the social network based on telephone communications data that is received by the television set-top boxes.

15. A content distributor as recited in claim 11, wherein the analytics module is further configured to associate user accounts corresponding to the users, and create the social network based on associated user accounts corresponding to the users that are included in the social network.

16. A content distributor as recited in claim 11, wherein the recommendation module is further configured to:
receive a request for the media content recommendation from a television client device when initiated by a user;
determine one or more social networks associated with the user; and
generate the media content recommendation to include a plurality of recommendations for media content based on the determined one or more social networks associated with the user.

17. One or more computer-readable media comprising computer-executable instructions that, when executed, direct a content distributor to:
form social networks of users based on an evaluation of communications data that is representative of communications between the users that are included in a social network;
compile media content data that is representative of media content utilized by the users in the social network; and
generate a media content recommendation based on the compiled media content data associated with the users in the social network.

18. One or more computer-readable media as recited in claim 17, further comprising computer-executable instructions that, when executed, direct the content distributor to receive the communications data from client devices that are associated with the users.

19. One or more computer-readable media as recited in claim 17, further comprising computer-executable instructions that, when executed, direct the content distributor to include the users in the social network based on telephone communications data that is received by television set-top boxes that are associated with the users.

20. One or more computer-readable media as recited in claim 17, further comprising computer-executable instructions that, when executed, direct the content distributor to include the users in the social network based on a threshold for a minimum number of the communications between the users that are included in the social network.
